(19) United States
(12) Patent Application Publication
(10) Pub. No.: US 2017/0346698 A1
(43) Pub. Date: Nov. 30, 2017

(54) DETERMINING BANDWIDTH REQUIREMENTS FOR NETWORK SERVICES

(71) Applicant: ARIA NETWORKS LIMITED, Bath (GB)

(72) Inventor: John CRICKETT, Chippenham Wiltshire (GB)

(21) Appl. No.: 15/531,275

(22) PCT Filed: Nov. 27, 2015
(86) PCT No.: PCT/GB2015/053646

§ 371 Date: May 26, 2017

(30) Foreign Application Priority Data
Nov. 28, 2014 (GB) 1421181.7

(51) Int. Cl. H04L 12/24; H04L 12/751; H04L 12/917

(52) U.S. Cl. CPC H04L 41/0896; H04L 47/76; H04L 41/0213; H04L 41/12; H04L 45/02

(57) ABSTRACT

Methods and systems for identifying the amount of a network's traffic that is attributable to each service running over the network. The method comprises generating a set of candidate demand vectors (each candidate demand vector comprising a predicted bandwidth value for each service) from the topology of the network, bandwidth utilization information for the network and routing information for the network; evaluating each of the candidate demand vectors against the bandwidth utilization information; and, determining if a stop condition is satisfied. If the stop condition is not satisfied then the set of candidate demand vectors is evolved. If, however, the stop condition is satisfied then the best candidate demand vector based on the evaluation is selected and output as the demand vector for the services.

### BACKGROUND

A network typically comprises a plurality of nodes connected by links. Such a configuration allows data or traffic to be sent between nodes via the links. Traffic or data that is sent from a particular start node to a particular end node is referred to herein as a service. Modern tools and protocols, such as NetFlow and SNMP (Simple Network Management Protocol), make it easy to determine how much data or traffic is sent over a particular link.

However, since multiple services can run across the same link it is not evident which part of the total traffic sent over a link is attributed to each particular service running over the link. For example, a network may comprise a first node A connected by a link to a second node B, the second node B is then connected via a link to a third node C, and the second node B is also connected via a link to a fourth node D. If there is a first service that runs from node A to node C then the traffic for that service is routed from A to B to C. Similarly, if there is a second service that runs from A to D then the traffic for that service is routed from A to B to D. So, even if it is known that 10 Gigabits of traffic is sent across the link between A and B (e.g. via measurement etc.) since both the first and second services run across the link it is not known what percentage of the traffic is attributable to each service.

Knowing how much traffic is attributed to each service is important for network planning, for example, to determine if the network is able to handle failure of a network link (e.g. does it have capacity when traffic is re-routed due to a failure?). For example, a network operator may want to know that if a link fails (e.g. the link between A and B) the traffic can be re-routed through the network via an alternate route and there is sufficient capacity on the route or that there would be congestion that they need to plan for. Since each service has a different pair of start and end nodes it is possible that different services that were running over the failed link may be re-routed over a different set of links. If it is not known how much traffic is attributed to each service then it is difficult to determine how much of the link traffic will be sent over the different re-routing routes. Without knowing how much of the link traffic will be sent over the different re-routing routes it is difficult to design a network topology that supports the network service demands in a failure scenario (e.g. when one or more nodes and/or links has failed) as well as steady-state conditions.

The embodiments described below are not limited to implementations which solve any or all of the disadvantages of known network traffic attribution systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

Described herein are methods and systems for identifying the amount of a network's traffic that is attributable to each service running over the network. The method comprises generating a set of candidate demand vectors (each candidate demand vector comprising a predicted bandwidth value for each service) from the topology of the network, bandwidth utilization information for the network, and routing information for the network; evaluating each of the candidate demand vectors against the bandwidth utilization information; and, determining if a stop condition is satisfied. If the stop condition is not satisfied then the set of candidate demand vectors is evolved. If, however, the stop condition is satisfied then the best candidate demand vector based on the evaluation is selected and output as the demand vector for the services.

A first aspect provides a system for simulating traffic flow through a network, the network having a plurality of services running over the network, at least two of the plurality of services having an initial unknown bandwidth, the system comprising: a candidate generation module configured to: generate a set of candidate demand vectors from a topology of the network, bandwidth utilization information for the network and routing configuration information for the network, wherein each candidate demand vector comprises a predicted bandwidth value for each service of the plurality of services running over the network; and periodically evolve the set of candidate demand vectors; a candidate evaluation module configured to periodically evaluate each of the candidate demand vectors against the bandwidth utilization information; a stop condition module configured to periodically determine if a stop condition is satisfied, and in response to determining the stop condition is satisfied select the best candidate demand vector from the set of candidate demand vectors based on the evaluation of the candidate demand vectors and output the predicted bandwidth values of the selected candidate demand vector; and a simulation module configured to simulate traffic flow through the network based on the output bandwidth values.

A second aspect provides a system to determine a bandwidth value for each service of a plurality of services running over a network, the system comprising: a candidate generation module configured to: generate a set of candidate demand vectors from a topology of the network, bandwidth utilization information for the network and routing configuration information for the network, wherein each candidate demand vector comprises a predicted bandwidth value for each service of the plurality of services; and periodically evolve the set of candidate demand vectors; a candidate evaluation module configured to periodically evaluate each of the candidate demand vectors against the bandwidth utilization information; and a stop condition module configured to periodically determine if a stop condition is satisfied, and in response to determining the stop condition is satisfied select the best candidate demand vector from the set of candidate demand vectors based on the evaluation of the candidate demand vectors and output the predicted bandwidth values of the selected candidate demand vector as the bandwidth values.

A third aspect provides a method of simulating traffic flow through a network, the network having a plurality of services running over the network, at least two of the plurality of services having an initial unknown bandwidth, the method comprising: generating, using a computing-based device, a set of candidate demand vectors from a topology of the network, bandwidth utilization information for the network and routing configuration information for the network, wherein each candidate demand vector comprises a predicted bandwidth value for each service of a plurality of services running over the network; periodically evaluating, using the computing-based device, each of the candidate demand vectors against the bandwidth utilization information; periodically determining, using the computing-based device, if a stop condition is satisfied; in response to determining the stop condition is not satisfied, evolving, using the computing-based device, the set of candidate demand vectors; in response to determining the stop condition is satisfied, selecting, using the computing-based device, the best candidate demand vector from the set of candidate demand vectors based on the evaluation of the candidate demand vectors and outputting the predicted bandwidth values of the selected candidate demand vector as bandwidth values for the plurality of services; and simulating traffic flow through the network based on the output bandwidth values.

A fourth aspect provides a computer-implemented method to determine a bandwidth value for each service of a plurality of services running over a network, the method comprising: generating a set of candidate demand vectors from a topology of the network, bandwidth utilization information for the network and routing configuration information for the network, wherein each candidate demand vector comprises a predicted bandwidth value for each service of the plurality of services; periodically evaluating each of the candidate demand vectors against the bandwidth utilization information; periodically determining if a stop condition is satisfied; in response to determining the stop condition is not satisfied, evolving the set of candidate demand vectors; and in response to determining the stop condition is satisfied, selecting the best candidate demand vector from the set of candidate demand vectors based on the evaluation of the candidate demand vectors and outputting the predicted bandwidth values of the selected candidate demand vector as the bandwidth values for the plurality of services.

A fifth aspect provides a computer readable storage medium having encoded thereon computer readable program code which when run by a computer causes the computer to perform the method of the fourth aspect.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

This acknowledges that firmware and software can be separately used and valuable. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an example network topology;

FIG. 2 is a schematic diagram of the network topology of FIG. 1 illustrating multiple services running over a single link;

FIG. 3 is table illustrating an example demand matrix;

FIG. 4 is a block diagram of an example system for determining how much of a network's traffic is attributable to each service running over the network;

FIG. 5 is a flow diagram of an example method of determining how much of a network's traffic is attributable to each service running over the network using the system of FIG. 4;

FIG. 6 is a schematic diagram illustrating a set of candidate demand vectors;

FIG. 7 is a schematic diagram illustrating generating a seed candidate demand vector;

FIG. 8 is a schematic diagram illustrating generating an error value for a link of the network of FIG. 1;

FIG. 9 is a chart illustrating example stop conditions;

FIG. 10 is a flow chart illustrating an example method for evolving the set of candidate demand vectors;

FIG. 11 is a schematic diagram illustrating generating child candidate demand vectors by mating parent candidate demand vectors;

FIG. 12 is a schematic diagram illustrating generating child candidate demand vectors by mutating parent candidate demand vectors; and

FIG. 13 is an example computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Described herein are methods and systems for determining how much of a network's traffic is attributable to each service (or part thereof (e.g. each Quality of Service (QoS) level within the service) running over the network. Each service represents traffic that is sent from a particular start node to a particular end or destination node. For example, one service may describe the traffic that is sent from a first node A to a second node B and another service may describe the traffic that is send from node B to node A. Accordingly, the methods and systems described herein determine how much of a network's traffic is from each pair of start and end nodes in the network.

The term “network” is used herein to mean any interconnection of elements for the transfer of data or information. A network may comprise a plurality of physical objects, such as a network of IP (Internet Protocol) routers, a telephone communications system, a utility distribution system or a network of blood vessels. Alternatively, a network may comprise a plurality of abstract objects, such as a data flow or social interactions. The topology of a network defines the specific interconnections or links between the objects of the network.

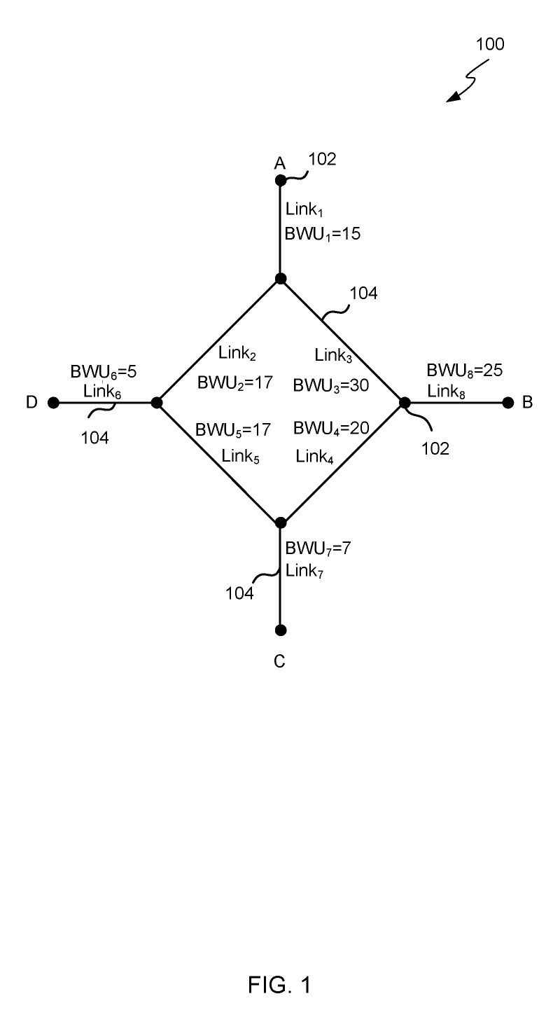

Reference is first made to FIG. 1 which illustrates an example network topology 100. The network topology 100 comprises a number of nodes 102 and links 104 that connect the nodes 102. Each node 102 represents a terminal point or intersection point of a network. A node may be, for example, a topology element such as a location in a network; a system; a physical element such as a router, switch terminal, hub, branch, intersection or the like; or a virtual element such as a channel. The nodes may be divided into edge nodes (e.g. nodes A, B, C, and D) that generate and absorb traffic and core nodes that act as traffic gateways.

Each link 104 provides a connection between two nodes. A link may be, for example, a physical element such as a cable, pipe or road; an abstract element such as a network link; or a virtual element such as a channel or frequency of a link or cable. Each link 104 typically has a capacity or bandwidth (BWₓ) that defines the amount of traffic or information that can be transferred between the two nodes connected by the link. Bi-directional links (i.e. links in which traffic can be sent in both directions) typically have the same bandwidth in both directions; however, in some cases the bandwidth may be different in each direction. For example, the bandwidth for traffic going from A to B may 10 Gbps whereas the bandwidth for traffic going from B to A may only be 5 Gbps. In these cases, bi-directional links may be assigned two bandwidth values, one for each direction of traffic flow. For simplicity, in the examples described herein, the bi-directional links have been assumed to have the same bandwidth in both traffic flow directions.

In FIG. 1 each link 104 is assigned a unique link identifier (Linkₓ) which uniquely identifies the link (e.g. the two nodes that it connects) and one or more bandwidth utilization values (BWUₓ). The bandwidth utilization value (BWUₓ) indicates the amount of the bandwidth that is being used or consumed by the services running over the network (e.g. the total traffic sent across the link).

A bi-directional link (i.e. a link in which traffic can be sent in both directions over the link (e.g. from A to B and from B to A)) may be assigned one bandwidth utilization value or it may be assigned two bandwidth utilization values. For example, in some cases a bi-directional link may be assigned a single bandwidth utilization value that represents both the amount of traffic from A to B and from B to A (e.g. it may be an average of the traffic in the two directions). In particular, a single bandwidth utilization value of 5 may indicate a bandwidth utilization of 5 for traffic flowing from A and B and a bandwidth utilization of 5 for traffic flowing from B and A.

In other cases a bi-directional link may be assigned two bandwidth utilization values—one that represents the amount of traffic sent in one direction (e.g. from A to B) and a second that represents the amount of traffic sent in the other direction(e.g. from B to A). For example, a bi-directional link between nodes A and B may be assigned a first bandwidth utilization value that represents the bandwidth utilization for traffic going from node A to node B; and a second bandwidth utilization value that represents the bandwidth utilization for traffic going from node B to node A.

A uni-directional link (i.e. a link in which traffic can only be sent in one direction (e.g. from A to B, but not from B to A)) may be assigned only a single bandwidth utilization value representing the bandwidth utilization for traffic in the single direction.

For simplicity, in the examples described herein each bi-directional link (e.g. between nodes A and B) has been assigned one bandwidth utilization value which can be understood a representing the bandwidth utilization for traffic from A and B and from B and A. However, it will be evident to a person of skill in the art that the principles and techniques can be equally applied to networks where the bi-directional links have been assigned two bandwidth utilization values.

In some cases the bandwidth utilization may be expressed as a bandwidth value (e.g. 5). The bandwidth value may, for example, be in units of Mbps (Megabits per second), Gbps (Gigabits per second), Tbps (terabits per second), OUTs, ODUs, DS1s, DS3s or any other suitable unit of measuring bandwidth. In other cases the bandwidth utilization may be expressed a percentage of the total bandwidth of the link (BWₓ), such as, 50%. However, it will be evident to a person of skill in the art that the bandwidth utilization may be expressed in other suitable forms. As described above, the bandwidth utilization(s) for a link 104 may be determined or identified using any known network measurement tool and/or protocol.

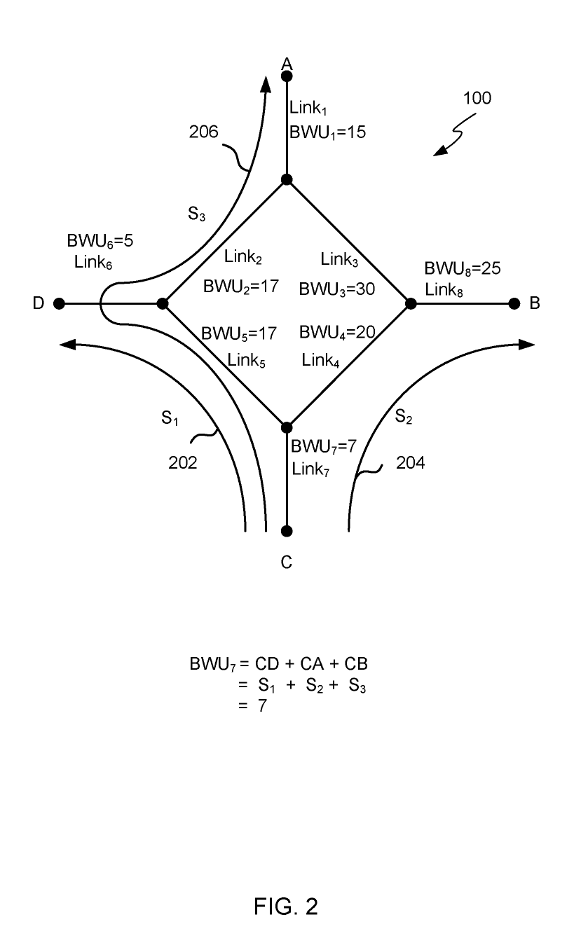

Since multiple services can run across the same link it is not evident which part of the total traffic sent over a particular link (e.g. bandwidth utilization) is attributed to each service running over the link. This is illustrated in FIG. 2. In particular, FIG. 2 shows the network topology 100 of FIG. 1 with three services S₁ 202, S₂ 204, and S₃ 206 running over the network. The first service S₁ 202 sends traffic or data from node C to node D; the second service S₂ 204 sends traffic or data from node C to node B; and the third service S₃ 206 sends traffic or data from node C to node A. The particular route (e.g. combination of links) the traffic for a particular service takes to get between the start and end nodes is dictated by the routing rules (e.g. defined by a routing protocol or the engineered path if it is an engineered solution) used by the network to route traffic.

In the example shown in FIG. 2, the first service S₁ 202 is routed via Link₇, Link₅ and Link₆; the second service S₂ 204 is routed via Link₇, Link₄ and Link₈; and the third service S₃ 206 is routed via Link₇, Link₅, Link₂ and Link₁. Since all three services S₁ 202, S₂, 204 and S₃ 206 send traffic from node C over Link₇ the bandwidth utilization (BWU₇) for Link₇ for traffic from node C is a combination of the traffic for each of the three services S₁ 202, S₂, 204 and S₃ 206. This can be represented by formula (1) shown below:

$$\begin{matrix}{BWU}_{7} = CD + CA + CB \\ = {S}_{1} + {S}_{2} + {S}_{3} \\ = 7\end{matrix} \qquad ( 1 )$$

Although the total amount of traffic sent over Link₇ (i.e. bandwidth utilization BWU₇) from node C is known, it is not known how much of the traffic is related to each of the three services S₁ 202, S₂, 204 and S₃ 206 sending traffic over the link from node C. Knowing how much traffic is attributed to each service is important for network planning, for example, to determine if the network is able to handle failure of a network link (e.g. does it have capacity when traffic is re-routed due to a failure?). For example, a network operator may want to know if a link fails whether the network will be able to handle re-routing of the services that were running over the link. Since each service has a different pair of start and end nodes it is possible that different services that were running over the failed link may be re-routed over a different set of links. If it is not known how much traffic is attributed to each service then it is difficult to determine how much of the link traffic will be sent over the different re-routing routes.

In general, once a network operator knows the requirement/bandwidth of each service running through a network the network operator can simulate the network under different conditions including, but not limited to, single failure; multiple failure; different topology; and engineered scenarios (e.g. changing the IGP (Interior Gateway Protocol) cost of a link in an IP (Internet Protocol) network to cause the traffic to flow elsewhere). Such engineered scenarios may be implemented to even out traffic flows and is often referred to as Automatic Cost Optimisation (ACO).

For example, if Link₅ fails, the traffic for the first and third services S₁ 202 and S₃ 206 will have to be re-routed. For example, the traffic for the first service S₁ 202 may be re-routed via Link₇, Link₄, Link₃, Link₂ and Link₆; and the traffic for the third service S₃ 206 may be re-routed via Link₇, Link₄, Link₃ and Link₁. If it is not known how much traffic is attributed to the first and third services S₁ 202 and S₃ 206 then it is difficult to determine if Link₄, Link₃, and Link₂ are appropriately sized to be able to handle the re-routed traffic from the first and third services S₁ 202 and S₃ 206 if there is a Link₅ failure.

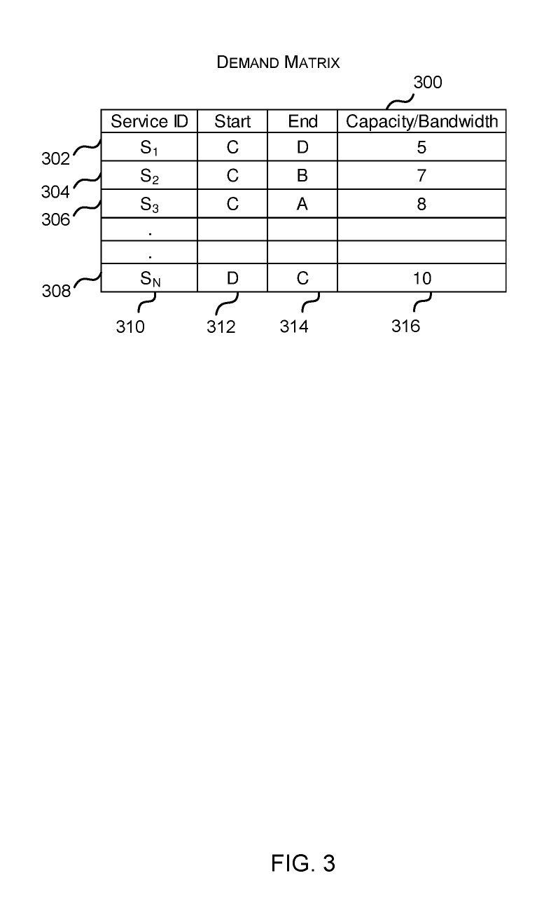

Accordingly, there is a desire to know how much of a network's traffic is attributed to each of the services running over the network. The amount of traffic that is attributed to each service may be represented by a demand matrix. An example demand matrix 300 is illustrated in FIG. 3. In particular, the demand matrix 300 of FIG. 3 comprises a number of rows 302, 304, 306 and 308 and columns 310, 312, 314, and 316.

There is a row 302, 304, 306 and 308 for each service that runs over the network and the columns 310, 312, 314 and 316 provide information about the corresponding service. Accordingly, where there are N services there are N rows in the demand matrix 300. In some cases each possible combination of start and end nodes is represented by a service. For example, the network topology 100 of FIGS. 1 and 2 has four possible start/end nodes (A, B, C and D) which results in 4″3=12 possible combinations of start and end nodes. Accordingly, in this example the corresponding service matrix would have twelve rows.

In some cases, as shown in FIGS. 1 and 2 only the edge nodes can be start and end nodes of a service. In other cases any node in the network can be a start or end node of a service.

In the example of FIG. 3 there are four columns 310, 312, 314 and 316. The first column 310 is used for the service identifier (e.g. S₁) which is an identifier assigned to the service to uniquely identify the service. The second column 312 is used to identify the start node of the service, and the third column 314 is used to identify the end node or destination node of the service. In some cases each node may be assigned an identifier that uniquely identifies the node. In the example shown in FIG. 3 each node is assigned a letter, but it will be evident to a person of skill in the art that this is an example only and other forms of unique identifiers may be used.

The fourth column 316 is used to identify the amount of traffic associated with the corresponding service (e.g. the amount of traffic that is sent from the specified source node to the specified destination node). The amount of traffic associated with a particular service may be referred to herein as a bandwidth value or a bandwidth requirement for the service. It is this fourth column 316 that is generally unknown.

It will be evident to a person of skill in the art that the demand matrix 300 of FIG. 3 is an example only and the demand matrix may comprise additional or alternative information; or the services and traffic attributed thereto may be represented in a different manner.

Known ways of determining the bandwidth requirements of the services in a network require a vast amount of information For example, one method is gravity modelling which is based on the principle of gravity that the force between two objects is proportional to the masses of the objects and the inverse of the squares of the distance between them. In particular, in gravity modelling for data networks the traffic between two nodes is assumed to be proportional to the total traffic of those nodes. Gravity modelling requires, however, a gravity model to be built. Another method is the Bayesian method which uses Bayesian inference techniques to identify the bandwidth requirements from a prior distribution of the traffic. Accordingly the Bayesian method requires an assumption about prior distribution of the traffic which may be generated either through estimation or based on previous knowledge. Another method is the maximum likelihood method which uses link covariance to determine a likelihood surface with a maximum point. The maximum likelihood method, however, requires several measurements per link (e.g. a time series).

Described herein are systems and methods for determining how much of a network's traffic is attributable to each service running over the network based on limited information. In particular, the systems and methods herein are able to relatively accurately determine the bandwidth requirements of each service based on only the network's topology, actual bandwidth utilization and routing information. Accordingly, the systems and methods described herein can relatively accurately determine the values for the fourth column 316 of the demand matrix 300 of FIG. 3. The systems and methods described herein are also generic meaning they can be used for any type of network with any number of nodes and links.

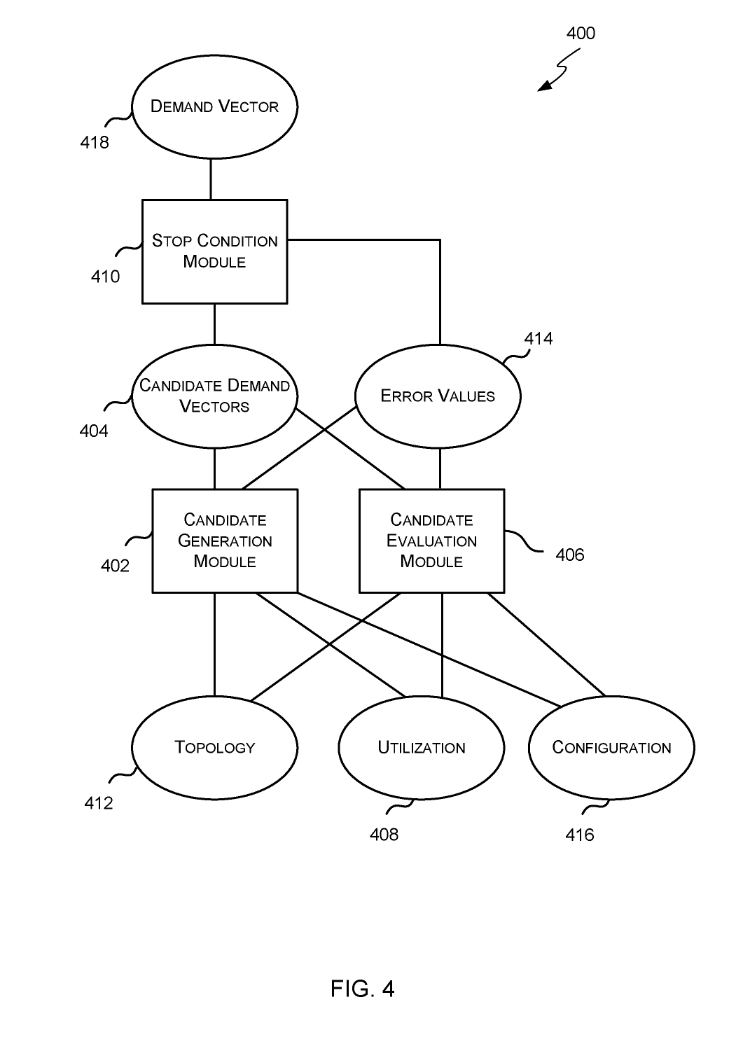

Reference is now made to FIG. 4 which illustrates an example system 400 for determining how much of a network's traffic is attributable to each service running over the network. In the system of FIG. 4 the traffic associated with the services in the network is represented by a demand vector (e.g. column 316 of the demand matrix 300 of FIG. 3). The system 400 uses an iterative process to refine and evaluate possible demand vectors to identify the demand vector representing the likeliest division of network traffic per service. Although the example system 400 uses a demand vector to represent the traffic associated with the services it will be evident to a person of skill in the art that the methods and principles described herein may be equally applied to other representations of the traffic associated with the services.

The system 400 comprises a candidate generation module 402 for generating and iteratively evolving a set of candidate demand vectors 404; a candidate evaluation module 406 for evaluating the candidate demand vectors to determine how well they map onto the bandwidth utilization information 408; and a stop condition module 410 for determining, based on the evaluation of the candidate demand vectors, when the iterative process can be stopped.

The candidate generation module 402 receives information on the topology of the network 412, and bandwidth utilization information 408 and generates a set of candidate demand vectors 404. The topology information 412 defines the nodes of the network and how they are interconnected. In particular, the topology 412 comprises the nodes and links of the network (e.g. how the nodes are connected). The topology 412 may also (where the bandwidth utilization information 408 expresses bandwidth utilization as a percentage of the bandwidth) comprise the bandwidth of each link. The candidate generation module 402 may be configured to identify the services of the network from the network topology 412 by identifying all of the potential start and end nodes in the network. As described above, the potential start and end nodes may comprise all of the nodes at which a service can start or end. Where services can only start and end at an edge node then the potential start and end nodes comprises only the edge nodes.

The bandwidth utilization information 408 comprises the bandwidth utilization information for each of the links of the network. As described above with respect to FIG. 1, the bandwidth utilization for a link represents the amount of traffic that is being sent over the link. The bandwidth utilization may, for example, be expressed as a specific bandwidth value, such as 5 Gbps, or as a percentage of the total bandwidth of the link (e.g. 70%).

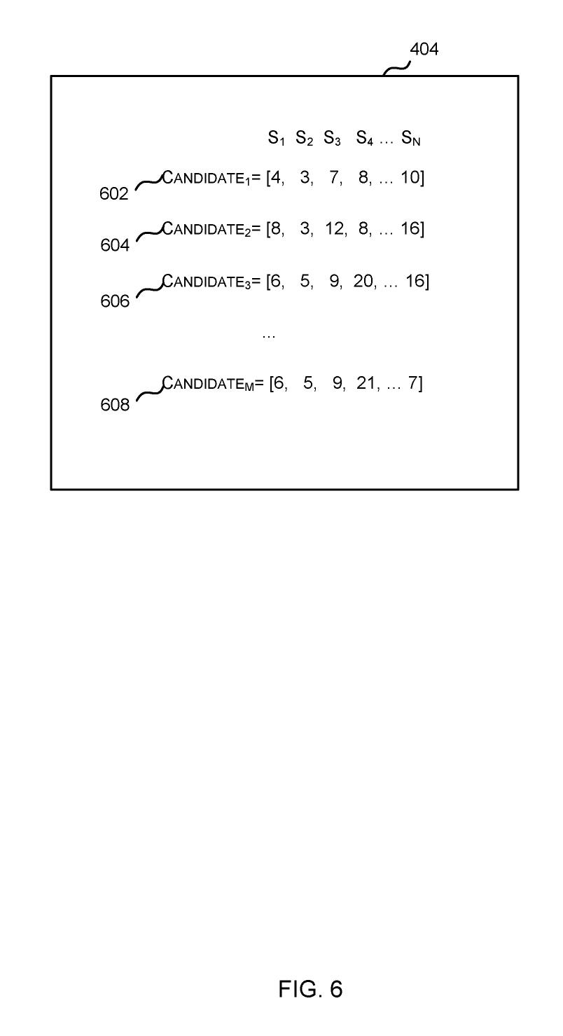

The candidate generation module 402 takes the network topology 412 and the bandwidth utilization information 408 and generates an initial set of candidate demand vectors 404. In some cases the candidate generation module 402 is configured to generate a predetermined number M, in one example 50, candidate demand vectors 404. Each candidate demand vector comprises a predicted bandwidth value for each of the identified services. In some cases the candidate demand vectors may be represented by a list of bandwidth values corresponding to the identified services. Example candidate demand vectors are described with reference to FIG. 6.

In some cases the candidate generation module 402 is configured to randomly generate M-1 candidate demand vectors and to generate one seed candidate demand vector. The seed candidate demand vector is designed to bring the set of candidate demand vectors closer to the actual demand vector sooner. Randomly generating a candidate demand vector may comprise randomly selecting bandwidth values for each of the services

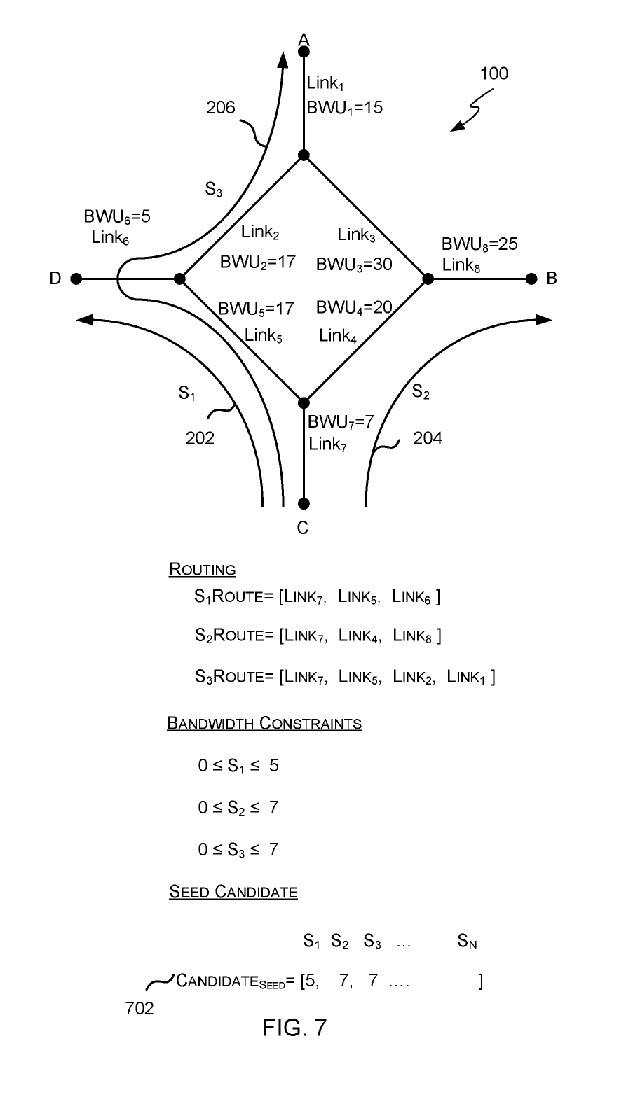

In some cases the seed candidate demand vector is generated to comprise the worst case bandwidth value for each service. Determining the worst case bandwidth value for a service may comprise determining the route of the service through the network and identifying the minimum bandwidth utilization of the links forming the route. An example method for generating the seed candidate demand vector is described with reference to FIG. 7. In these cases randomly selecting a bandwidth value for a service may comprise randomly selecting a bandwidth value between 0 and the minimum bandwidth utilization of the links forming the route for that service.

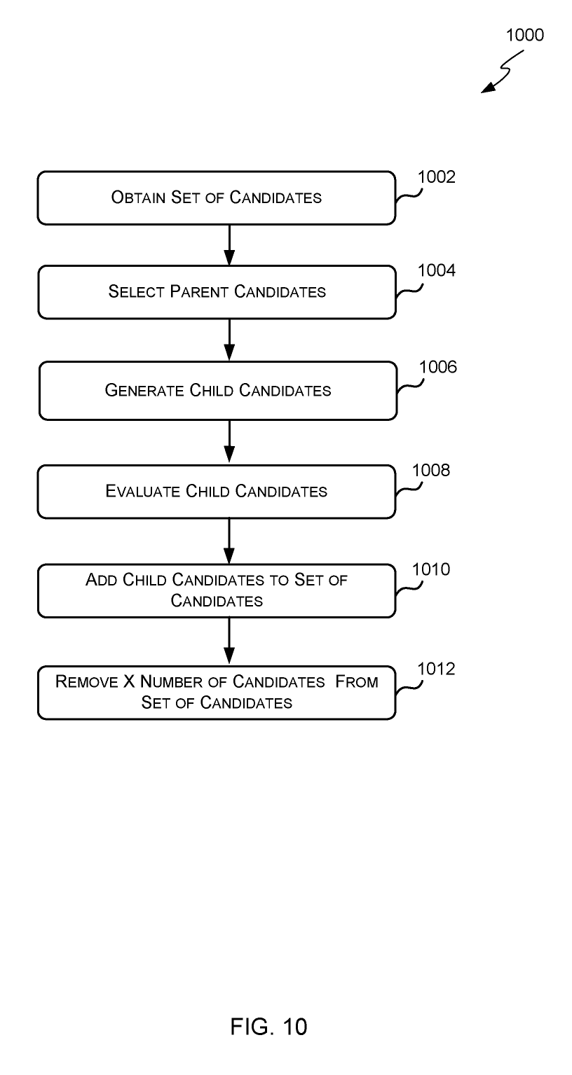

The candidate generation module 402 is also configured to periodically update or evolve the set of candidate demand vectors 404 by selecting one or more candidate demand vectors from the set of candidate demand vectors, forming new candidate demand vectors from the selected candidate demand vectors (e.g. via mutation and/or mating (e.g. crossover)), adding the new candidate demand vectors to the set of candidate demand vectors, and selecting M candidate demand vectors from the set of candidate demand vectors to continue. In some cases the best M candidate demand vectors are selected (e.g. based on the error values) and in other cases the M candidate demand vectors are selected using other criteria or methods. For example, in some cases the worse candidate is retained in the set of candidate demand vectors to preserve diversity. Deciding to retain the worse candidate demand matrix is driven by a probability determined by the fitness of the candidate. An example method for updating or evolving the set of candidate demand vectors 404 that may be executed by the candidate generation module 402 is described with reference to FIG. 10.

The candidate evaluation module 406 takes the set of candidate demand vectors 404 and evaluates each of the candidate demand vectors based on how well the candidate demand vector matches the bandwidth utilization information 408. In some cases the candidate evaluation module 406 is configured to generate an error value 414 for each candidate demand vector. The error value provides a quantitative measure of how well the candidate demand vector matches the bandwidth utilization information 408. In some cases, the higher the error value the poorer the candidate, and the lower the error value the better the candidate.

In some cases the error value may be generated by computing an error value for each link (ErrorLink)) and summing or averaging the values for each link to get an error value for the candidate demand vector. In some cases the error for a particular link (ErrorLinkₓ)may be generated by determining the routing of each service (e.g. the links used to get from the start node to the end node) and then comparing the actual bandwidth utilization for the link to the sum of the predicted bandwidth values for the services running over that link. Where a link is bi-directional an error value for the link may be obtained by generating an error value for each direction and then summing or averaging the error values for each direction. For example, an error value for a particular direction for a particular link may be generated by comparing the actual bandwidth utilization for the link in that particular direction to the sum of the predicted bandwidth values for the services that run traffic over that link in that particular direction.

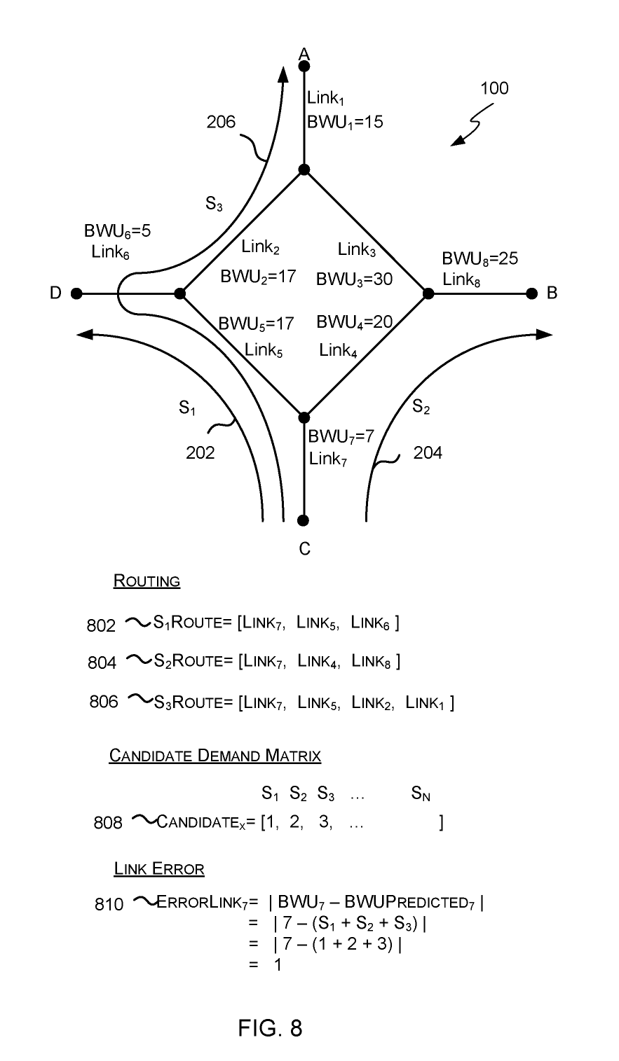

The routing of each service may be determined from configuration information 416 about the network. The configuration information 416 comprises information about the configuration of the network that is used to determine how traffic is routed through the network. For example, the configuration information 416 may comprise the routing rules used to route traffic through the network and any other information about the configuration of the network that may affect the routing of traffic through the network. In some cases there may be specific routing rules etc. for each service. An example method for generating a link error value is described with reference to FIG. 8.

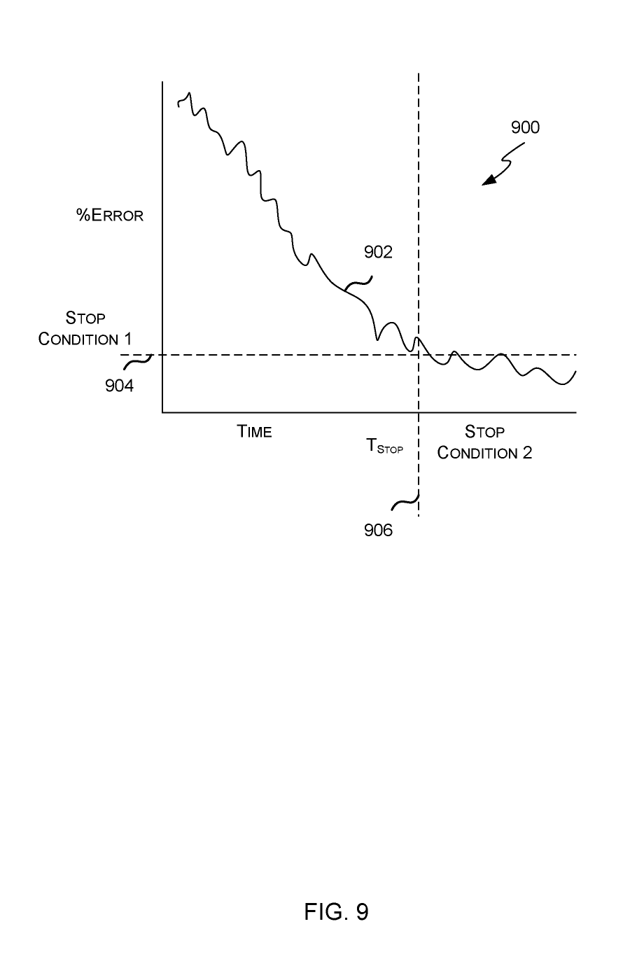

The stop condition module 410 determines whether at least one stop condition is met and thus the iterative process of evaluating and updating/evolving the candidate demand vectors 404 can end. A stop condition may be, for example, if the best error value in the set of error values 414 is less than a predetermined percentage of the total network bandwidth utilization; or if the iterative process has run a predetermined period of time. Example stop conditions will be described in further detail with reference to FIG. 9.

Once the stop condition module 410 determines that a stop condition is met then the stop condition module 410 selects the candidate demand vector or vectors that has/have the lowest error value and outputs the selection(s) as the final estimated demand vector 418.

In some cases the system may also comprise a simulation module (not shown) configured to receive the outputted demand vector and to simulate traffic flow through the network based on the output demand vector. The simulation module may be configured to simulate the network under different conditions including, but not limited to, a failure scenario (e.g. failure of one or more nodes and/or links of the network); a different topology; and engineered scenarios (e.g. changing the IGP (Interior Gateway Protocol) cost of a link in an IP (Internet Protocol) network to cause the traffic to flow elsewhere). Such engineered scenarios may be implemented to even out traffic flows and is often referred to as Automatic Cost Optimisation (ACO).

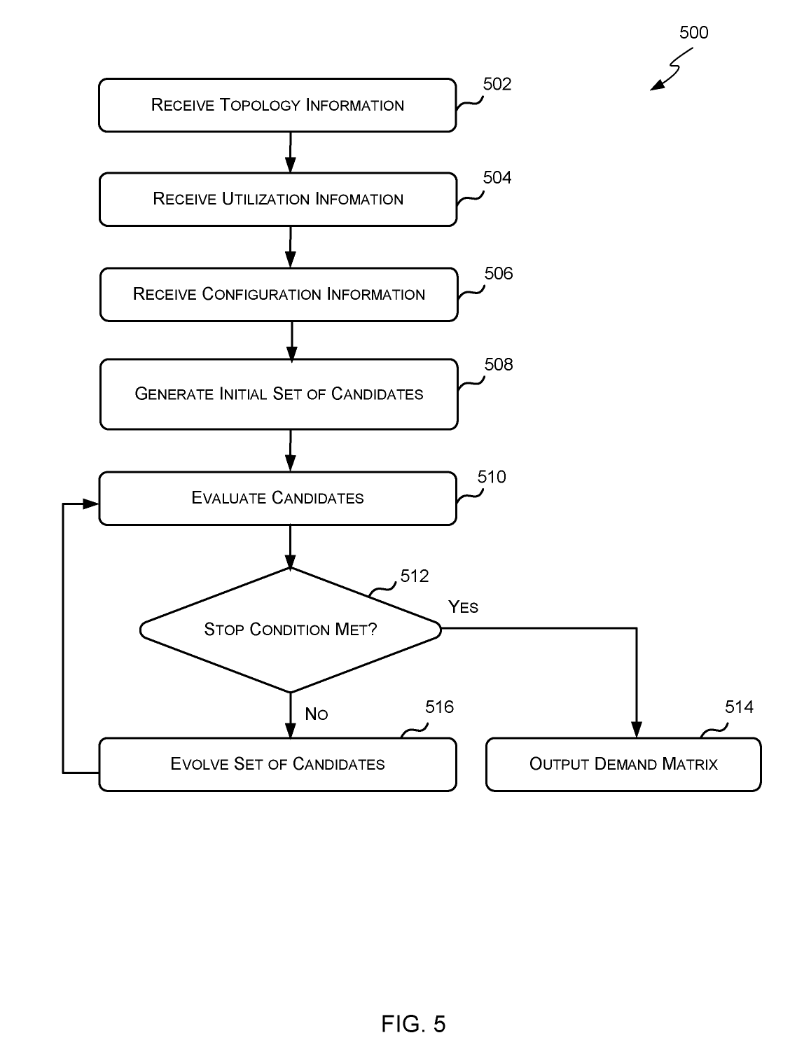

Reference is now made to FIG. 5 which illustrates a method 500 for determining how much of a network's traffic is attributable to each service running over the network using the system 400 of FIG. 4. The method 500 identifies a demand vector representing the amount of traffic associated with each service running over the network through an iterative process that generates a set of candidate demand vectors, evaluates the candidate demand vectors, and evolves or updates the set of candidate demand vectors to create a set of stronger candidate demand vectors. Since the quality of the candidate demand vectors increases with each iteration, each iteration increases the probability that the set of candidate demand vectors comprises the correct or actual demand matrix.

The method 500 begins at block 502 where the topology 412 of the network is received. As described above, the topology defines the nodes of the network and how they are interconnected. In particular, the topology 412 comprises the nodes and links of the network where each link connects two nodes. The topology 412 may also comprise the bandwidths of the links. FIG. 1 shows an example topology defined by eight nodes (including edge nodes A, B, C and D) and eight links (Link₁-Link₈) connecting the nodes. Once the topology 412 has been received the method 500 proceeds to block 504.

At block 504, the bandwidth utilization information 408 is received. As described above, the bandwidth utilization information 408 comprises a bandwidth utilization for each link of the network. The bandwidth utilization for a link describes how much traffic is being sent across the link. Where a link is bi-directional the bandwidth utilization information 408 may comprise a separate bandwidth utilization value for each direction of the link (e.g. for traffic from A to B and for traffic from B to A). The bandwidth utilization may be expressed, for example, as an amount of bandwidth, such as 5 Gbps, or as a percentage of the available bandwidth of the link. Once the bandwidth utilization information 408 has been received the method 500 proceeds to block 506.

At block 506, the routing configuration information 416 is received. As described above, the routing configuration information 416 comprises information about the configuration of the network that is used to determine how traffic is routed in the network. The configuration information 416 may comprise the routing rules (i.e. the rules uses to determine how traffic is routed through the network), and/or the type of each link (e.g. copper or fibre). Once the configuration information has been received the method 500 proceeds to block 508.

It will be evident to a person of skill in the art that blocks 502 to 506 may be executed in any order or in parallel. For example, the system 400 may concurrently receive the topology 412, the bandwidth utilization information 408 and the configuration information 416.

At block 508, the candidate generation module 402 generates an initial set of M (e.g. 50) candidate demand vectors 404 from the topology 412, the utilization information 408 and the configuration information 416. Each candidate demand vector comprises a predicted bandwidth value for each service (e.g. each pair of start and end nodes) of the network. As described above the predicted bandwidth value specifies the amount of traffic the service sends through the network (e.g. the amount of traffic that is sent from the start node to the end node).

The term “vector” is used herein to mean an ordered list of elements. A list of each service (e.g. start nodes and end nodes) and the order in which they are listed in the vector may be maintained in addition to the vectors so that the bandwidth values can be mapped back to the corresponding service. An example of a set of candidate demand vectors is described with reference to FIG. 6.

Generating the initial set of candidate demand vectors may comprise: (i) identifying all of the services in the network; and (ii) for each candidate demand vector, assigning each of the identified services a bandwidth value. As described above, a service describes the traffic that is sent from a start node to an end node. In some cases, identifying all of the potential services in the network comprises analyzing the topology 412 to determine the edge nodes of the network and defining a service for each possible pairing of edge nodes with the first edge node of the pair being the start node and the second edge node of the pair being the end node. For example, if there are four edge nodes (A, B, C, D) there are twelve possible pairings of edge nodes (AB, AC, AD, BA, BC DB, DC) and thus there will be twelve services.

In some cases, M-1 of the candidate demand vectors are randomly generated and one candidate demand vector is generated as a seed candidate matrix. Randomly generating a candidate matrix may comprise randomly generating a bandwidth value for each service. In some cases the bandwidth values may range from 0, meaning no traffic is sent between the start node and the end node, and a maximum bandwidth value for that service. In some cases, the maximum bandwidth value for a service may be the minimum bandwidth utilization of the links forming the route for that service.

The seed candidate demand vector is designed to bring the set of candidate demand vectors to the correct solution faster. In some cases the seed candidate demand vector is generated to comprise the worst case bandwidth value for each service. As described above, the traffic for each service takes a particular route through the network which comprises one or more links, and each link has a bandwidth utilization (i.e. the amount of traffic that is sent across the link) as defined in the utilization information 408. Each service cannot produce more traffic than the lowest or minimum bandwidth utilization value for the links it traverses (i.e. the links that form its route). For example, if a service runs over two links that have utilization bandwidth values of 5 and 10, the maximum amount of traffic for the service (e.g. sent between the start and end nodes) is 5 because each of the two links must carry at least the traffic for that service.

Accordingly, in some cases determining the seed candidate demand vector (e.g. the worst case demand matrix) comprises (i) determining the route through the network for each service (i.e. the set of links that the traffic traverses to get from the start node to the end node); and (ii) for each service, selecting the lowest bandwidth utilization value (as set out in the utilization information 408) for the links forming the route as the bandwidth value. The route through the network for each service may be determined from the topology 412 and the configuration information 416. In particular, the route through the network from a start node to an end node of the network can be determined from the routing rules and other information used to make a routing decision.

Once the initial set of candidate demand vectors has been generated in step 508, the method 500 proceeds to block 510.

At block 510, the candidate evaluation module 406 evaluates the candidate demand vectors in the set of candidate demand vectors 404 against the utilization information 408 (i.e. the bandwidth utilization values for the links in the network).

In some cases evaluation of a candidate demand vector comprises assigning the candidate demand vector an error value 414 that is a quantitative measure of how well the candidate demand vector matches the utilization information 408 (i.e. the bandwidth utilization values for the links in the network). In one example, generating the error value for a candidate demand vector comprises generating an error value for each link of the network and summing the error values for all of the links to produce the error value for the candidate demand vector as shown in equation (2):

ErrorCandidateₓ=Σᵢ₌₁^{K}ErrorLinkᵢ (2)

where ErrorCandidateₓis the error value for the x^{th} candidate demand vector, ErrorLinkᵢ is the error for Linkᵢ and K is the number of links in the network. Alternatively the error value may be the average of the link errors as shown in equation (3):

$${ErrorCandidate}_{x} = \frac{{\sum }_{i = 1}^{K} {ErrorLink}_{i}}{K} \qquad ( 3 )$$

Each link error value (ErrorLinkᵢ) provides a quantitative measure of how well the candidate demand vector matches the bandwidth utilization for that link. In some cases the error link value is determined by (i) determining the routing (e.g. set of links traversed to get from the source node to the destination node) for each service; (ii) summing the bandwidths for the services that are routed over the particular link to determine the predicted bandwidth utilization for the link based on the candidate demand vector; and (iii) determining the difference between the actual bandwidth utilization for the link (as per the utilization information) and the predicted bandwidth utilization. Where a link is bi-directional an error value for the link may be obtained by generating an error value for each direction and then summing or averaging the error values for each direction. For example, an error value for a particular direction for a particular link may be generated by comparing the actual bandwidth utilization for the link in that particular direction to the sum of the predicted bandwidth values for the services that run traffic over that link in that particular direction. An example method for generating an error value for a link will be described with reference to FIG. 8.

Once the set of candidate demand vectors 404 have been evaluated (e.g. error values have been determined for each candidate demand vector), the method 500 proceeds to block 512.

At block 512 the stop condition module 410 determines whether at least one stop condition has been met. The stop condition(s) may be, for example, if the best error value in the set of error values 414 is less than a predetermined percentage (e.g. 5%) of the total bandwidth utilization of the network; and/or if the iterative process has run a predetermined time period. If the stop condition module 410 determines that one or more stop conditions are met then the method 500 proceeds to block 514 where the stop condition module 410 selects the candidate demand vector or the candidate demand vectors 404 with the best error value and outputs it/them as the the final estimated demand vector 418. If, however, the stop condition module 410 determines that one or more stop conditions have not been met then the method 500 proceeds to block 516.

At block 516, the candidate generation module 402 updates or evolves the set of candidate demand vectors 404 in an attempt to increase the quality of the candidate demand vectors in the set. In particular, it is very unlikely that the initial set of candidate demand vectors comprises the actual demand vector therefore the set of candidates is evolved to pull the candidate demand vectors closer to the actual demand vector.

In some cases evolving the set of candidate demand vectors comprises selecting one or more of the candidate demand vectors from the set of candidate demand vectors, generating one or more new candidate demand vectors from the selected candidate demand vectors, adding the new candidate demand vectors to the set and selecting M candidate demand vectors from the set to continue. In some cases the best M candidate demand vectors (e.g. based on the error values) are selected. In other cases the M candidates may be randomly selected.

For example, in some cases the candidate generation module 402 is configured to select two or more parent candidate demand vectors from the set of candidate demand vectors. The parent candidate demand vectors may be the candidates with the best error values or the parent candidate demand vectors may be selected in another manner (e.g. they may be randomly selected) or selected using other criteria. The candidate generation module 402 then generates one or more candidate demand vectors from the parent candidate demand vectors using known techniques such as mating and mutation, or a combination thereof. The candidate generation module 402 then adds the child demand matrices to the set of candidate demand vectors. An example method for updating or evolving the set of candidate demand vectors is described with reference to FIG. 10.

The method then proceeds back to block 510 where the candidate evaluation module 406 evaluates (e.g. assigns an error value to) each candidate demand vector and updates the set of candidate demand vectors to M candidate demand vectors where M is the number of candidate demand vectors initially generated in block 508. This process of evolving the set of candidate network topologies is repeated until a stop condition is satisfied.

Reference is now made to FIG. 6 which shows a set of candidate demand vectors 404 comprising M candidate demand vectors 602, 604, 606 and 608 where each candidate demand vector 602, 604, 606 and 608 comprises N elements where N is the number of services in the network. Each element of the vector is a bandwidth value that corresponds to a particular service. The position of the bandwidth element in the vector identifies which service the bandwidth value corresponds to. For example, in FIG. 6, the first bandwidth value corresponds to service S₁, the second bandwidth value corresponds to service S₂, the third bandwidth value corresponds to service S₃ and so on. In particular, the first candidate demand vector Candidate, 602 specifies service S₁ has a bandwidth requirement of 4, service S₂ has a bandwidth requirement of 3, service S₃ has a bandwidth requirement of 7 etc.

Reference is now made to FIG. 7 which illustrates an example of generating a seed candidate demand vector, Candidate_{Seed} 702, for the network 100 of FIGS. 1 and 2. As described above, the network comprises eight nodes 102 (including four edge nodes A, B, C and D) and eight links (Link₁-Link₈) connecting the nodes. There are three services S₁ 202, S₂ 204 and S₃ 206 running over the network. The first service S₁ 202 sends traffic from node C to node D, the second service S₂ 204 sends traffic from node C to node B, and the third service S₃ 206 sends traffic from node C to node A.

To generate a seed candidate demand vector, first the routes (the set of links traversed to get from the source node to the destination) for each service are determined from the configuration information. In the example if FIG. 7, it is determined from the configuration information that the first service S₁ is routed from node C to node D via Link₇, Link₅ and Link₆; the second service S₂ is routed from node C to node B via Link₇, Link₄, and Link₈; and the third service S₃ is routed from node C to node A via Link₇, Link₅, Link₂ and Link₁.

Next it is determined what the maximum bandwidth value is for each service based on the determined routes and the utilization information 408. As described above, determining the maximum bandwidth value for a service may comprises selecting the minimum bandwidth utilization of the links comprising the route for the service. For example, the maximum bandwidth for the first service S₁ 202 is equal to the minimum of the bandwidth utilizations of Link₇, Link₅ and Link₆. In FIG. 7 Link₇ has a bandwidth utilization (BWU₇) of 7, Link₅ has a bandwidth utilization (BWU₅) of 17 and Link₆ has a bandwidth utilization (BWU₆) of 5, making the maximum bandwidth for the first service S₁ 202 equal to 5. Similarly, the maximum bandwidth for the second service S₂ 204 is equal to the minimum of the bandwidth utilizations of Link₇, Link₄ and Link₈. In FIG. 7 Link₇ has a bandwidth utilization (BWU₇) of 7, Link₄ has a bandwidth utilization (BWU₄) of 20 and Link₈ has a bandwidth utilization (BWU₈) of 25, making the maximum bandwidth for the second service S₂ 204 equal to 7.

Once the maximum bandwidth has been determined for each service the seed candidate demand vector, Candidate_{Seed} 702 is generated by populating the bandwidth values of the candidate demand vector with the maximum bandwidth values for each service. For example, since the maximum bandwidth for the first service S₁ 202, second service S₂ 204 and third service S₃ 206 is 5, 7 and 7 respectively the corresponding elements of the seed candidate demand vector Candidate_{Seed} 702 are set to 5, 7, and 7 respectively. This represents the absolute maximum bandwidth values for all of the services.

Reference is now made to FIG. 8 which illustrates an example of generating an error value for a link of the network 100 of FIGS. 1 and 2 for a candidate demand vector. As described above, the network 100 comprises eight nodes 102 (including four edge nodes A, B, C and D) and eight links (Link₁-Link₈) connecting the nodes. There are three services S₁ 202, S₂ 204 and S₃ 206 running over the network. The first service S₁ 202 sends traffic from node C to node D, the second service S₂ 204 sends traffic from node C to node B, and the third service S₃ sends traffic from node C to node A. Although there are only three services shown in FIG. 8 it will be evident to a person of skill in the art that there may be other services (not shown) that are also running across the network.

To generate an error value for a link, first the routes (the set of links traversed to get from the source node to the destination) for each service are determined from the configuration information. In the example if FIG. 8, it is determined from the configuration information that the first service S₁ is routed from node C to node D via Link₇, Link₅ and Link₆; the second service S₂ is routed from node C to node B via Link₇, Link₄, and Link₈; and the third service S₃ is routed from node C to node A via Link₇, Link₅, Link₂ and Link₁. This is represented by routing vectors 802, 804 and 806 respectively.

Next, for each link, the routing information is used to identify which services send traffic over the link and in which direction. For example, we can see from the routing vectors 802, 804 and 806 that all three services S₁, S₂ and S₃ 202, 204 and 206 send traffic from node C over Link₇ and both the first and third services S₁ 202 and S₃ 206 send traffic from node C over Link₅.

Once the services running over each link have been identified, a predicted bandwidth utilization for each link for each direction is calculated by summing the predicted bandwidth values (i.e. the bandwidth values specified in the candidate demand vector) for the services identified as running over that link in that direction. This is illustrated in equation (4) below:

BWUPredicted_{y}=Σⱼ₌₁^{N}Candidateₓ[j]; for each j where Link_{y} is in the route for Sj (4)

where BWUPredicted_{y} is the predicted bandwidth utilization for Link_{y} and Candidateₓ[j] is the predicted bandwidth value for the j^{th} service (Sⱼ) and N is the number of services. In FIG. 8 the predicted bandwidth utilization for Link₇ for traffic from node C for the candidate demand vector 808 is equal to the sum of the predicted bandwidth for the first, second and third services S₁ 202, S₂ 204 and S₃ 206. Accordingly, the predicted bandwidth utilization for Link₇ for traffic from node C for the candidate demand vector 808 of FIG. 8 is equal to 1+2+3=6.

Once the predicted bandwidth utilization for a link for a particular direction is determined the error for the link for that direction is then determined to be the absolute difference between the actual bandwidth utilization (as specified in the utilization information) and the predicted bandwidth utilization (as determined from the information in the candidate demand vector). This is illustrated in equation (5) below:

ErrorLink_{y}=|BWU_{y}−BWUPredicted_{y}| (5)

Accordingly, in FIG. 8 the error for Link₇ for traffic from node C is equal to 7 (the actual bandwidth utilization, BWU₇)−6 (the predicted bandwidth utilization, BWUPredicted₇) =1. Where a link is bi-directional the total error value for the link will be the sum or average of the error values for each direction.

Once an error value is generated for each link a total error for the candidate demand vector is determined by either summing the error values for each link (e.g. in accordance with equation (2) described above) or by determining the average of the errors values for the links (e.g. in accordance with equation (3) described above).

Reference is now made to FIG. 9 which illustrates two example stop conditions. In particular FIG. 9 shows a graph 900 of the best error value (e.g. the lowest error value) as a percentage of the total bandwidth utilization of the network 902 over time (e.g. as more iterations are performed). The best error value as a percentage of the total bandwidth utilization of the network may be calculated, where the candidate demand vector error (ErrorCandidateₓ) is the sum of the error values as shown in equation (2), by dividing the error value by the sum of the bandwidth utilization values for all of the links in the network as shown in equation (6):

$$\% {ErrorCandidate}_{x} = \frac{{ErrorCandidate}_{x}}{{\sum }_{i = 1}^{K} {BWU}_{i}} \qquad ( 6 )$$

It can be seen in FIG. 9 that as more iterations are performed the better the best error percentage becomes. There will be a point in the iterative process where the error percentage for the best error value drops below a predetermined value 904. In some cases the stop condition module 410 is configured to determine a stop condition is satisfied if the % error of the best error value is below the predetermined percentage value 904.

Alternatively, or in addition, the stop condition module 410 may be configured to determine a stop condition if a predetermined time, Tₛₜₒₚ 906 has elapsed since the process began.

It will be evident to a person of skill in the art that these are examples only and other stop conditions may be used.

Reference is now made to FIG. 10 which illustrates an example method 1000 for evolving the set of candidate demand vectors which may be executed by the candidate generation module 402 and the candidate evaluation module 406. The objective of the evolving is to increase the quality of the candidate demand vectors in the set 404. The example method 1000 of FIG. 10 comprises identifying one or more parent candidate demand vectors in the set of candidate demand vectors, generating child candidate demand vectors from the parent candidate demand vectors, evaluating the child candidate demand vectors, adding the child candidate demand vectors to the set of candidate demand vectors and selecting M candidates from the combined set.

The method 1000 starts at block 1002 where the candidate generation module 402 obtains the current set of candidate demand vectors 404. Once the current set of candidate demand vectors 404 has been obtained, the method 1000 proceeds to block 1004.

At block 1004, the candidate generation module 402 selects a predetermined number, in one example 2, of parent candidate demand vectors from the set of candidate demand vectors 404. The parent candidate demand vectors may, for example, be selected based on their associated error value (e.g. the best candidate demand vectors based on their error values may be selected as the parents) or they may be randomly selected. It will be evident to a person of skill in the art that these are examples only and the parent candidate demand vectors may be selected using any suitable criteria or method. Once the parent candidate demand vectors have been selected the method 1000 proceeds to block 1006.

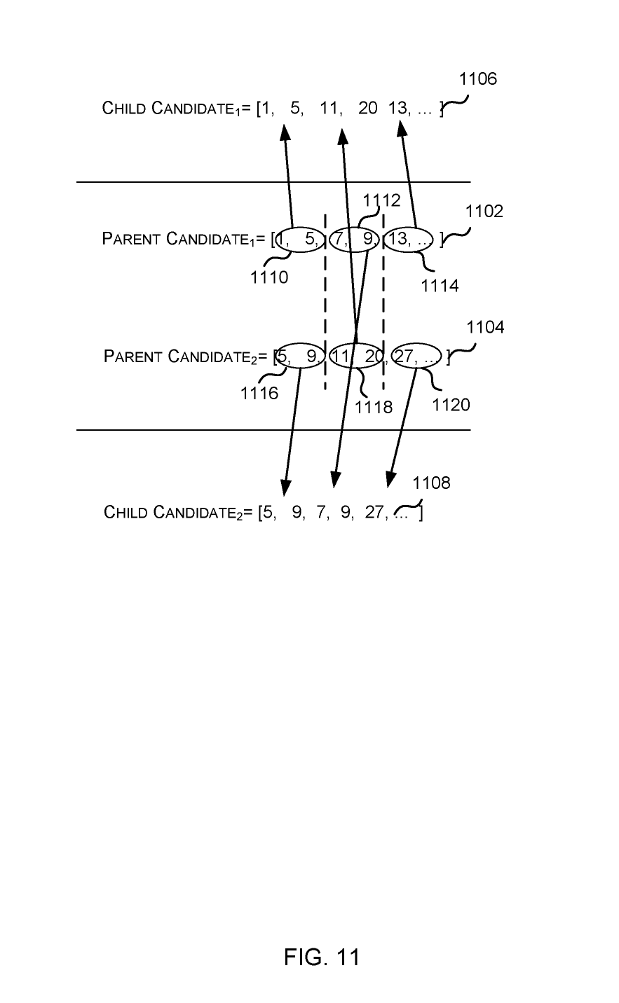

At block 1006, the candidate generation module 402 generates one or more child candidate demand vectors from the parent candidate demand vectors selected in block 1004. In some cases, the child candidate demand vectors may be generated from the parent candidate demand vectors by mating or combining the parent candidate demand vectors using a known technique such as, but not limited to crossover. In some cases mating may comprise taking portions of multiple parent candidate demand vectors and combining them to form a new child candidate demand vector. An example of generating child candidate demand vectors by mating or combining parent candidate demand vectors will be described with reference to FIG. 11.

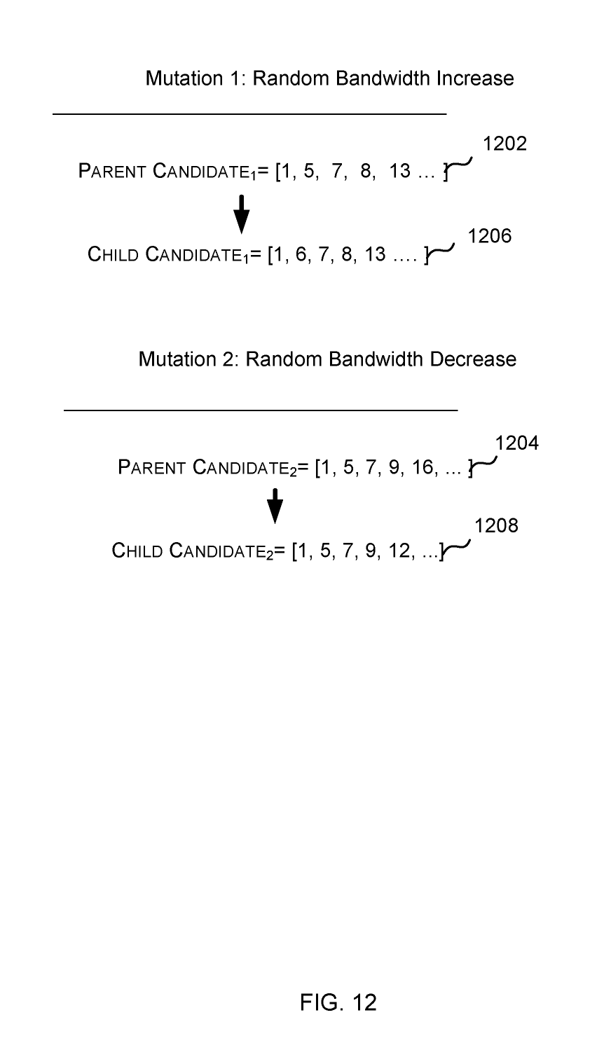

In other cases, the child candidate demand vectors may be generated by mutating the parent candidate demand vectors. As is known to those of skill in the art mutation involves altering a parent candidate demand vector. In some cases this may comprise randomly adjusting (e.g. increasing/decreasing) one of the elements (i.e. bandwidth values) in the parent candidate demand vector by a random percentage. Once the child candidate demand vectors have been generated the method 1000 proceeds to block 1008. An example of generating child candidate demand vectors by mutating parent candidate demand vectors will be described with reference to FIG. 12.

In other cases, a combination of mutation and mating may be used to generate one or more child candidate demand vectors. Once the child candidate demand vectors have been generated the method 1000 proceeds to block 1008.

At block 1008, the child candidate demand vectors generated at block 1006 are evaluated (e.g. by the candidate evaluation module 406). In some cases evaluation comprises determining an error value, as described above, for each child candidate demand vector. Once the child candidate demand vectors have been evaluated, the method 1000 proceeds to block 1010.

At block 1010, the candidate generation module 402 adds the child candidate demand vectors to the set of candidate demand vectors. For example, if the set of candidate demand vectors obtained in block 1002 comprised fifty candidate demand vectors and two child candidate demand vectors are generated then the updated set of candidate demand vectors will comprise fifty-two candidate demand vectors. Once the child candidate demand vectors are added to the set of candidate demand vectors, the method 1000 proceeds to block 1012.

At block 1012, the candidate evaluation module 406 removes X candidate demand vectors from the combined set of candidate demand vectors where X is the number of child candidate demand vectors generated at block 1006.

In some cases the X “worst” candidate demand vectors may be removed from the set. Selecting and removing the “worst” candidate demand vectors may comprise ranking the candidate demand vectors in the combined set based on their associated error value and removing the X candidate demand vectors with the worst (e.g. highest) error values. For example, if the set of candidate demand vectors obtained in block 1002 comprises fifty candidate demand vectors, two child candidate demand vectors are generated and added to the set, the two worst (e.g. based on error values) are removed from the set to bring the total number of candidate demand vectors in the set back to fifty.

In other cases the X candidates that are removed may be selected using other criteria or methods. For example, in some cases the X candidates may be randomly selected.

Once X candidate demand vectors have been removed from the set, the method 1000 ends.

Reference is now made to FIG. 11 which illustrates an example of generating child candidate demand vectors by mating or combining parent candidate demand vectors. In the example, two parent candidate demand vectors 1102 and 1104 are selected from the set of candidate demand vectors 404. As described above the parent candidate demand vectors may be selected from the set of candidate demand vectors based on their quality (e.g. based on their error values) or they may be randomly selected from the set of candidate demand vectors 404.

Two child candidate demand vectors 1106 and 1108 are then generated by combining aspects (e.g. bandwidth values) of the two parent candidate demand vectors 1102 and 1104 so that the child candidate demand vectors 1106 and 1108 comprise a combination of bandwidth values from both parent candidate demand vectors 1102 and 1104. In particular, in the example shown in FIG. 11 each of the two parent candidate demand vectors 1102 and 1104 are divided into three parts 1110, 1112, 1114 and 1116, 1118, 1120. The first and third parts 1110 and 1114 of the first parent candidate demand vector 1102 are combined with the second part 1118 of the second parent candidate demand vector 1104 to form the first child candidate demand vector 1106. Then the second part 1112 of the first parent candidate demand vector 1102 is combined with the first and third parts 1116 and 1120 of the second parent candidate demand vector 1104 to form the second child candidate demand vector 1108. This technique is called crossover as different parts of a parent candidate demand vector are sent to different child candidate demand vectors.

Although FIG. 11 illustrates generating child candidate demand vectors by combining two parent candidate demand vectors, it will be evident to a person of skill in the art that the method could be similarly applied to generate child candidate demand vectors by combining more than two parent candidate demand vectors by taking bandwidth values from each of the parent candidate demand vectors.

Reference is now made to FIG. 12 which illustrates an example of generating child candidate demand vectors by mutating parent candidate demand vectors. In the example shown in FIG. 12 two parent candidate demand vectors 1202 and 1204 are selected from the set of candidate demand vectors 404. As described above the parent candidate demand vectors may be selected from the set of candidate demand vectors based on on their quality (e.g. based on their fitness value) or they may be selected used other criteria or another method (e.g. they may randomly selected).

Two child candidate demand vectors 1206 and 1208 are then created from a mutation of one of the parent candidate demand vectors 1202 and 1204. As described above mutation comprises altering the parent candidate demand vector in some manner. In the example shown in FIG. 12 the first child candidate demand vector 1206 is created from the first parent candidate demand vector 1202 through a mutation process that randomly increases the bandwidth of one of the services by 20%. For example, the first child candidate demand vector 1206 is generated by increasing the the second bandwidth value from the first parent candidate demand vector 1202 from 5 to 6. Other mutation methods may randomly increase more than one bandwidth and the amount of each increase may be randomly selected.

In the example shown in FIG. 12, the second child candidate demand vector 1208 is created from the second parent candidate demand vector 1204 through a mutation process that randomly decreases one of the bandwidth values of the second parent candidate demand vector 1204 by 25%. For example, the second child candidate demand vector 1208 is generated by decreasing the the fifth bandwidth value from the second parent candidate demand vector 1204 by 25% from 16 to 12. Other mutation methods may randomly decrease more than one bandwidth and the amount of each decrease may be randomly selected.

In some cases bandwidth values may be both increased and decreased in the same child candidate demand vector. Also, in some cases child candidate demand vectors may be created through both mating and mutation. For example, a child candidate demand vector may be generated by mating two parent candidate demand vectors, the mated candidate demand vector may then be mutated by, for example, increasing or decreasing one or more of the bandwidth values.

Although in the examples described above the bandwidth is determined/identified for each service in the network, in other examples, each link and each service may be divided into a plurality of different quality of service (QoS) levels. For example, each link may have a bandwidth utilization value for each QoS and the traffic for each service can be divided into one or more QoS levels. In these examples, the systems and methods described above can be modified to identify a demand vector that has an entry (e.g. bandwidth value) for each QoS level for each service. In particular, in these examples, instead of identifying the bandwidth for each service, the systems and methods described above can be used to identify the bandwidth for each QoS for each service.

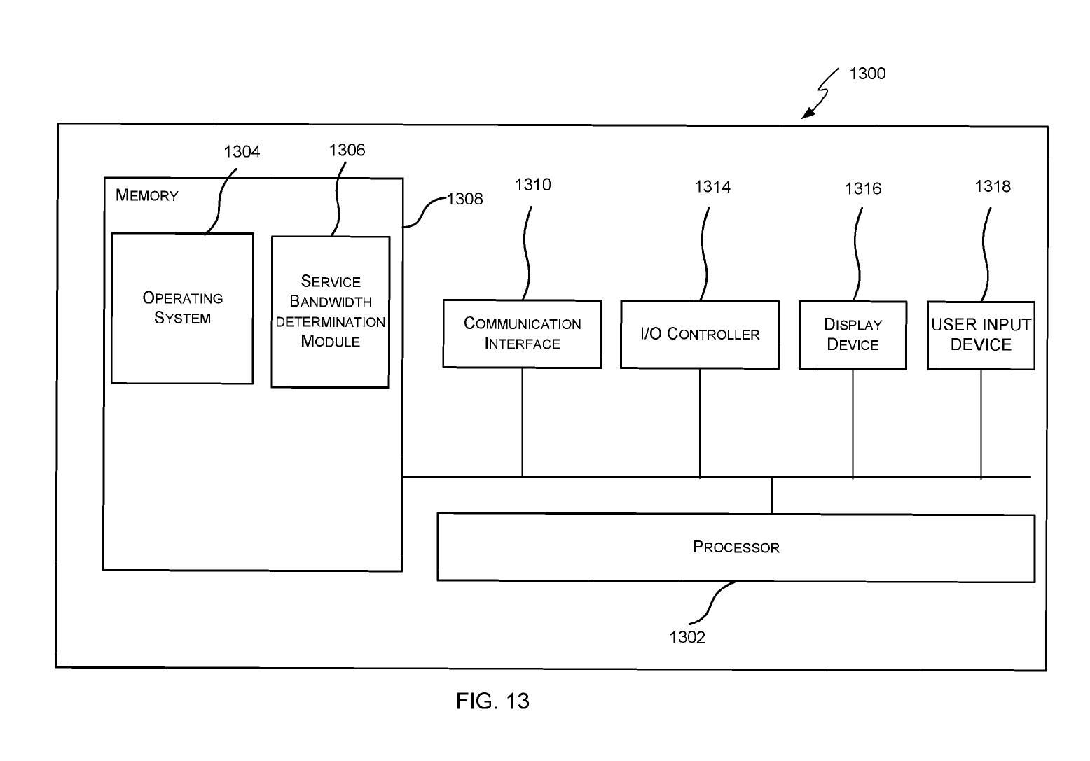

Reference is now made to FIG. 13 which illustrates various components of an exemplary computing-based device 1300 which may be implemented as any form of a computing and/or electronic device, and in which embodiments of the methods and systems described herein may be implemented.

Computing-based device 1300 comprises one or more processors 1302 which may be microprocessors, controllers or any other suitable type of processors for processing computer executable instructions to control the operation of the device in order to identify the bandwidth requirements of multiple services running over a network. In some examples, for example where a system on a chip architecture is used, the processors 1302 may include one or more fixed function blocks (also referred to as accelerators) which implement a part of the method of identifying the bandwidth requirements of the services in a network in hardware (rather than software or firmware). Platform software comprising an operating system 1304 or any other suitable platform software may be provided at the computing-based device to enable application software 1306, such as a service bandwidth determining module to be executed on the computing based device 1300.

The computer executable instructions may be provided using any computer-readable media that is accessible by computing based device 1300. Computer-readable media may include, for example, computer storage media such as memory 1308 and communications media. Computer storage media (i.e. non-transitory machine readable media), such as memory 1308, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 1308) is shown within the computing-based device 1300 it will be appreciated that the storage may be distributed or located remotely and accessed via a network or other communication link (e.g. using communication interface 1310).

The computing-based device 1300 also comprises an input/output controller 1312 arranged to output display information to a display device 1314 which may be separate from or integral to the computing-based device 1300. The display information may provide a graphical user interface. The input/output controller 1312 is also arranged to receive and process input from one or more devices, such as a user input device 1316 (e.g. a mouse or a keyboard). In an embodiment the display device 1314 may also act as the user input device 1316 if it is a touch sensitive display device. The input/output controller 1312 may also output data to devices other than the display device, e.g. a locally connected printing device (not shown in FIG. 13).

The term ‘processor’ and ‘computer’ are used herein to refer to any device, or portion thereof, with processing capability such that it can execute instructions. The term ‘processor’ may, for example, include central processing units (CPUs), graphics processing units (GPUs or VPUs), physics processing units (PPUs), digital signal processors (DSPs), general purpose processors (e.g. a general purpose GPU), microprocessors, any processing unit which is designed to accelerate tasks outside of a CPU, etc. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1.-45. (cancelled)

46. A system to determine a bandwidth value for each service of a plurality of services running over a network, the system comprising:
a candidate generation module configured to:
generate a set of candidate demand vectors from a topology of the network, bandwidth utilization information for the network and routing configuration information for the network, wherein each candidate demand vector comprises a predicted bandwidth value for each service of the plurality of services; and
periodically evolve the set of candidate demand vectors;
a candidate evaluation module configured to periodically evaluate each of the candidate demand vectors against the bandwidth utilization information; and
a stop condition module configured to periodically determine if a stop condition is satisfied, and in response to determining the stop condition is satisfied select the best candidate demand vector from the set of candidate demand vectors based on the evaluation of the candidate demand vectors and output the predicted bandwidth values of the selected candidate demand vector as the bandwidth values.

47. The system of claim 46, wherein the candidate generation module is configured to generate the set of candidate demand vectors from only the topology of the network, the bandwidth utilization information for the network, and the routing configuration information for the network.

48. The system of claim 46, wherein evaluating a candidate demand vector comprises generating an error value for the candidate demand vector, the error value being a quantitative measure of how well the candidate demand vector matches the bandwidth utilization information.

49. The system of claim 48, wherein the topology of the network comprises a plurality of links and generating the error value for the candidate demand vector comprises generating an error value for each link and combining the error values for each link to generate the error value for the candidate demand vector.

50. The system of claim 49, wherein the bandwidth utilization information for the network comprises a bandwidth utilization value for each link, and the error value for a link is a quantitative measure of how well the candidate demand vector matches the bandwidth utilization value for the link.

51. The system of claim 50, wherein each service is defined by a start node and a destination node and generating an error value for a link comprises:
identifying, for each service, the set of links taken to get from the start node to the destination node based on the topology of the network and the routing configuration information;
identifying, for the link, each service where the corresponding set of links comprises the link;
generating a predicted bandwidth utilization value for the link by combining the predicted bandwidth values for the identified services as specified in the candidate demand vector; and
setting the error value for the link to the absolute difference between the bandwidth utilization as specified in the utilization information and the predicted bandwidth utilization.

52. The system of claim 46, wherein generating the set of candidate demand vectors comprises generating a plurality of candidate demand vectors with randomly selected predicted bandwidth values, and generating a single seed candidate demand vector.

53. The system of claim 52, wherein generating the seed candidate demand vector comprises determining a maximum bandwidth value for each service based on the topology of the network, the bandwidth utilization information for the network and the routing configuration information for the network, and setting the predicted bandwidth values of the seed candidate demand vector to the maximum bandwidth values.

54. The system of claim 53, wherein:
the topology of the network comprises a plurality of links connecting a plurality of nodes;
each service is defined by a start node and a destination node;
the bandwidth utilization information comprises a bandwidth utilization value for each link; and
determining a maximum bandwidth value for a service comprises:
identifying the set of links taken to get from the start node to the destination node of that service based on the topology of the network and the routing configuration information for the network;
identifying the minimum bandwidth utilization value for the links forming the set of links; and
determining the maximum bandwidth value for that service to be the identified minimum bandwidth utilization value.

55. The system of claim 46, wherein evolving the set of candidate demand vectors comprises generating at least one additional candidate demand vector, adding the at least one additional candidate demand vector to the set of candidate demand vectors, and removing x of the candidate demand vectors from the set of candidate demand vectors, wherein x is the number of additional candidate demand vectors generated.

56. A computer-implemented method to determine a bandwidth value for each service of a plurality of services running over a network, the method comprising:
generating a set of candidate demand vectors from a topology of the network, bandwidth utilization information for the network and routing configuration information for the network, wherein each candidate demand vector comprises a predicted bandwidth value for each service of the plurality of services;
periodically evaluating each of the candidate demand vectors against the bandwidth utilization information;
periodically determining if a stop condition is satisfied;
in response to determining the stop condition is not satisfied, evolving the set of candidate demand vectors; and
in response to determining the stop condition is satisfied, selecting the best candidate demand vector from the set of candidate demand vectors based on the evaluation of the candidate demand vectors and outputting the predicted bandwidth values of the selected candidate demand vector as the bandwidth values for the plurality of services.

57. The method of claim 56, wherein the set of candidate demand vectors is generated from only the topology of the network, the bandwidth utilization information for the network, and the routing configuration information for the network.

58. The method of claim 56, wherein evaluating a candidate demand vector comprises generating an error value for the candidate demand vector, the error value being a quantitative measure of how well the candidate demand vector matches the bandwidth utilization information.

59. The method of claim 58, wherein the topology of the network comprises a plurality of links and generating the error value for the candidate demand vector comprises generating an error value for each link and combining the error values for each link to generate the error value for the candidate demand vector.

60. The method of claim 59, wherein the bandwidth utilization information for the network comprises a bandwidth utilization value for each link, and the error value for a link is a quantitative measure of how well the candidate demand vector matches the bandwidth utilization value for the link.

61. The method of claim 60, wherein each service is defined by a start node and a destination node and generating an error value for a link comprises:
identifying, for each service, the set of links taken to get from the start node to the destination node based on the topology of the network and the routing configuration information;
identifying, for the link, each service where the corresponding set of links comprises the link;
generating a predicted bandwidth utilization value for the link by combining the predicted bandwidth values for the identified services as specified in the candidate demand vector; and
setting the error value for the link to the absolute difference between the bandwidth utilization as specified in the utilization information and the predicted bandwidth utilization.

62. The method of claim 56, wherein generating the set of candidate demand vectors comprises generating a plurality of candidate demand vectors with randomly selected predicted bandwidth values, and generating a single seed candidate demand vector.

63. The method of claim 62, wherein generating the seed candidate demand vector comprises determining a maximum bandwidth value for each service based on the topology of the network, the bandwidth utilization information for the network and the routing configuration information for the network, and setting the predicted bandwidth values of the seed candidate demand vector to the maximum bandwidth values.

64. The method of claim 63, wherein:
the topology of the network comprises a plurality of links connecting a plurality of nodes;
each service is defined by a start node and a destination node;
the bandwidth utilization information comprises a bandwidth utilization value for each link; and
determining a maximum bandwidth value for a service comprises:
identifying the set of links taken to get from the start node to the destination node of that service based on the topology of the network and the routing configuration information for the network;
identifying the minimum bandwidth utilization value for the links forming the set of links;
determining the maximum bandwidth value for the service to be the identified minimum bandwidth utilization value.

65. A computer readable storage medium having encoded thereon computer readable program code which when run by a computer causes the computer to perform the method of claim 56.
